(19) United States
(12) Patent Application Publication
(10) Pub. No.: US 2013/0133812 A1
(43) Pub. Date: May 30, 2013

(54) MANUFACTURING METHOD OF PNEUMATIC TIRE AND MANUFACTURING APPARATUS OF PNEUMATIC TIRE

(71) Applicant: Toyo Tire & Rubber Co., Ltd., Osaka (JP)

(72) Inventors: Masayoshi Abe, Osaka-shi (JP); Toshiharu Teshima, Osaka-shi (JP)

(73) Assignee: TOYO TIRE & RUBBER CO., LTD., Osaka (JP)

(21) Appl. No.: 13/682,435

(22) Filed: Nov. 20, 2012

(30) Foreign Application Priority Data
Nov. 24, 2011 (JP) 2011-256353

(51) Int. Cl. B29D 30/10

(52) U.S. Cl. CPC B29D 30/10
USPC 156/117; 156/397

(57) ABSTRACT

Two extruders are located at positions which are mutually shifted by 180 degrees around a rotation shaft of a rotary support, and are arranged at the same position in the rotation shaft direction of the rotary support, and each time the rotary support is rotated 180 degrees, the two extruders and the rotary support are caused to relatively move in the rotation shaft direction of the rotary support. In this manner, at least a portion of the pneumatic tire is molded by winding the rubber strip members onto the rotary support.

### BACKGROUND OF THE INVENTION

1. Field of the Invention

The present invention relates to a manufacturing method of a pneumatic tire and a manufacturing apparatus of the pneumatic tire.

2. Background Art

In general, a tire is configured of a plurality of tire rubber members and a plurality of reinforcing members whose chief material is a tire cord. Typically, the tire is configured such that individual units such as a rubber inner liner unit, a rubber tread unit, a rubber sidewall unit and a rubber rim strip unit are formed from rubber members corresponding to their respective required characteristics, and are then assembled with a carcass layer which is a reinforcing member containing cords, a belt layer, a bead body or the like.

In order to mold the rubber member configuring the tire as described above, a method has been known where an unvulcanized rubber strip member extruded in a ribbon shape from an extruder is wound by a portion being overlapped along the circumferential direction of the tire on a rotary support such as a molding drum.

In such a method, in order to shorten the time for winding the rubber strip member on the rotary support, that is, to reduce the manufacturing time, WO2008/26240 discloses a method whereby rubber strip members, extruded from two extruders which are arranged around the radial direction of the rotary support, are wound on the rotary support.

However, in the method disclosed in the above WO2008/26240, the rubber strip member is spirally wound on the rotary support. Therefore, a surplus protruding rubber portion is formed at both ends of the molded rubber member in the tire width direction. As a result, it is necessary to cut off the surplus rubber portion after the winding has been completed.

In addition, at both ends of the rubber member in the tire width direction, the rubber strip member is wound in parallel to the circumferential direction of the tire which is orthogonal with respect to the tire width direction, and the rubber strip member is spirally wound at the other portion, by being inclined with respect to the circumferential direction of the tire. In this manner, the protruding surplus rubber portion does not occur at both ends of the molded rubber member in the tire width direction. However, the rubber strip members are overlapped very much in the vicinity of both ends in the tire width direction and the rubber increases in quantity. Accordingly, there is a problem where weight balance deteriorates.

### SUMMARY OF THE INVENTION

The present invention is made in view of the above-mentioned problem, and an object thereof is to provide a manufacturing method of a pneumatic tire and a manufacturing apparatus of the pneumatic tire capable of shortening the manufacturing time without deterioration of the weight balance.

In a manufacturing method of a pneumatic tire according to an embodiment, while unvulcanized rubber strip members extruded from two extruders are supplied onto a rotary support, the rotary support is rotated, and at least a portion of the pneumatic tire is molded by winding the rubber strip members onto the rotary support. The two extruders are located at positions which are mutually shifted by 180 degrees around a rotation shaft of the rotary support, and are arranged at the same position in the rotation shaft direction of the rotary support. Each time the rotary support is rotated 180 degrees, the two extruders and the rotary support are relatively moved in the rotation shaft direction of the rotary support.

In addition, a manufacturing apparatus of a pneumatic tire according to the present embodiment includes two extruders that extrude unvulcanized rubber strip members, a rotary support, and a controller that controls the two extruders and the rotary support. The two extruders are located at positions which are mutually shifted by 180 degrees around a rotation shaft of the rotary support, and are arranged at the same position in the rotation shaft direction of the rotary support. The controller rotates the rotary support while the rubber strip members extruded from the two extruders are supplied onto a rotary support. Each time the rotary support is rotated 180 degrees, the two extruders and the rotary support are relatively moved in the rotation shaft direction of the rotary support. At least a portion of the pneumatic tire is molded by winding the rubber strip members onto the rotary support.

### BRIEF DESCRIPTION OF THE DRAWINGS

FIG. 1 is a schematic view illustrating a configuration of a manufacturing apparatus of a pneumatic tire according to an embodiment of the present invention.

FIG. 2 is a plan view of the manufacturing apparatus of a pneumatic tire illustrated in FIG. 1.

FIG. 3 is a view where a rubber member molded by the manufacturing apparatus of a pneumatic tire illustrated in FIG. 1 is developed on a plane.

### DETAILED DESCRIPTION OF THE INVENTION

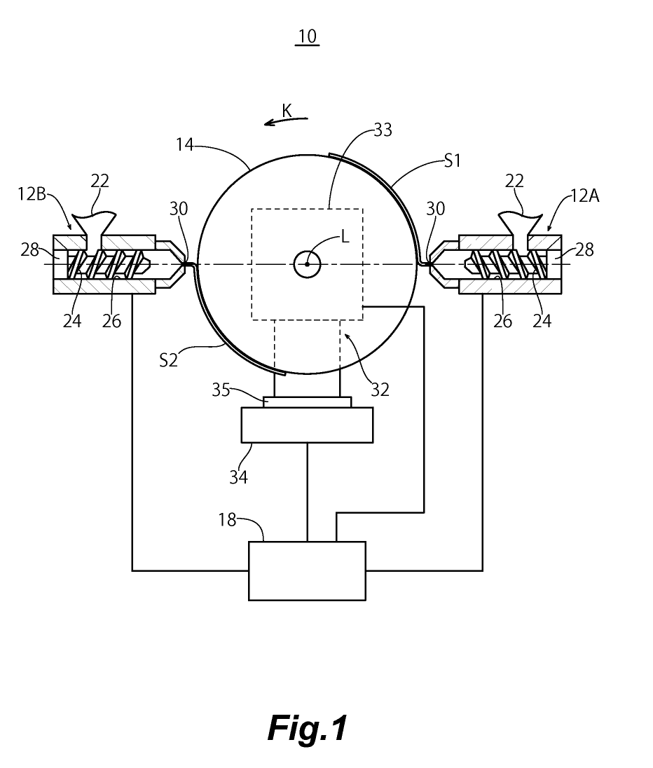

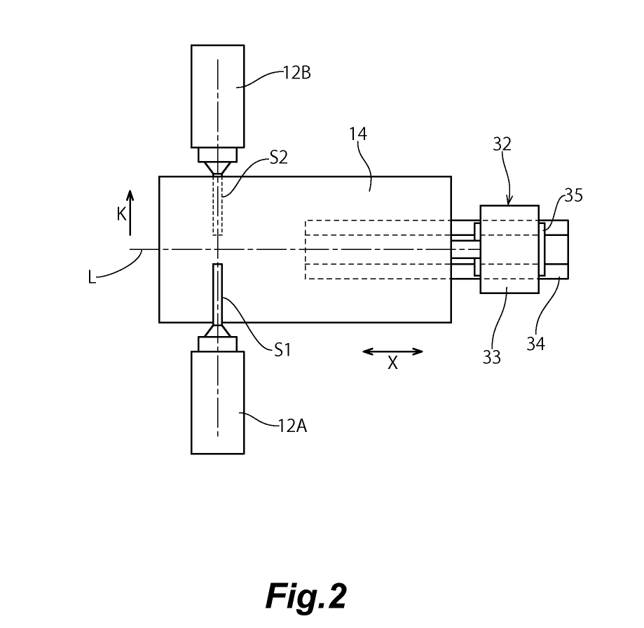

As illustrated in FIGS. 1 and 2, a pneumatic tire manufacturing apparatus (hereinafter referred to as a manufacturing apparatus) 10 according to the present embodiment includes two extruders 12A and 12B, a rotary support 14 and a controller 18. As the controller 18 controls the two extruders 12A and 12B, and the rotary support 14, the manufacturing apparatus 10 extrudes unvulcanized rubber strip members S1 and S2 in a ribbon shape from the two extruders 12A and 12B, while supplying the extruded rubber strip members S1 and S2 onto the rotary support 14, rotates the rotary support 14 around a rotation shaft L, winds the rubber strip members S1 and S2 on the rotary support 14, and molds a rubber member configuring the pneumatic tire, for example, such as a rubber inner liner unit, a rubber tread unit, or a rubber sidewall unit.

In detail, two extruders 12A and 12B are located at positions which are mutually shifted by 180 degrees around the rotation shaft L of the rotary support 14, and are arranged at the same position in the rotation shaft direction X of the rotary support 14.

As illustrated in FIG. 1, one extruder 12A includes a hopper 22 into which a rubber material is introduced, a screw 24 which feeds the rubber material forward while applying heat to the rubber material, a barrel 26 which has a cylindrical shape and has the screw 24 inside, a screwdriver 28 which drives the screw 24, and a discharge port 30 which opens to the front end in a shape corresponding to the cross-sectional shape of the rubber strip member S1. The extruder 12A extrudes the rubber material with low viscosity from the discharge port 30, forms the rubber strip member S1, which has a cross-sectional shape corresponding to the shape of the discharge port 30, and supplies the rubber strip member S1 onto the outer peripheral surface of the rotary support 14.

The rubber strip member S1 extruded from the extruder 12A is wound around the rotary support 14 in parallel to a direction (that is, the circumferential direction of the rotary support 14) orthogonal with respect to a rotation shaft direction X of the rotary support 14.

The other extruder 12B has the same structure as the above-described extruder 12A. Accordingly, with regard to the other extruder 12B, the detailed description will be omitted by reference to the same reference numerals as the extruder 12A in FIG. 1. The rubber strip member S2 extruded from the discharge port 30 is supplied onto the outer peripheral surface of the rotary support 14 and is wound in parallel to the circumferential direction of the rotary support 14.

Furthermore, in order to describe winding positions on the rotary support 14 between the rubber strip member S1 extruded from one extruder 12A and the rubber strip member S2 extruded from the other extruder 12B, different reference numerals are respectively given to the rubber strip member S1 extruded from one extruder 12A and the rubber strip member S2 extruded from the other extruder 12B. However, any rubber strip member is made of the same material and has the same shape. In addition, the extruders 12A and 12B are formed by the known mechanism and thereby are not particularly limited, but a gear pump may be provided between each distal end of the extruders 12A and 12B, and the discharge port 30. To provide the gear pump is particularly preferred for more precise controllability of the extruded amount of the rubber strip members S1 and S2 extruded from the discharge port 30.

Any of the two extruders 12A and 12B is configured so as to move close to and apart from the rotary support 14 using a movement mechanism. The extruders 12A and 12B move close to the rotary support 14, then supply the rubber strip members S1 and S2 to the rotary support 14, start the winding operation, and move away from the rotary support 14 when the winding operation is completed.

The rotary support 14 is driven by a driver 32, is rotated around the rotation shaft L, and moves in the rotation shaft direction X. The driver 32 is configured by a servo motor 33, a deceleration mechanism for connecting the servo motor 33 to the rotary support 14, a base 35 which slides on a linear guide 34 extending along the rotation shaft direction X of the rotary support 14, a drive circuit or the like.

Furthermore, in the embodiment, the rotary support 14 is moved with respect to the two extruders 12A and 12B, but the two extruders 12A and 12B and the rotary support 14 may be moved relatively. The two extruders 12A and 12B may be moved with respect to the rotary support 14 at the same speed and in the same direction.

The controller 18 controls the overall operations of the two extruders 12A and 12B and the rotary support 14 based on a control program stored in a memory. While controlling the two extruders 12A and 12B so as to supply the rubber strip members S1 and S2 to the rotary support 14 at a constant speed, the controller 18 controls the driver 32 such that the rotary support 14, being rotated in one direction K, moves along the rotation shaft direction X.

More specifically, the controller 18 controls the two extruders 12A and 12B such that the extruding amount (extruding speed) of the rubber strip member S1 supplied to the rotary support 14 from one extruder 12A may become equal to the extruding speed of the rubber strip member S2 supplied to the rotary support 14 from the other extruder 12B.

In addition, the controller 18 controls the rotation of the rotary support 14 such that the extruding speed of the rubber strip members S1 and S2 extruded from the two extruders 12A and 12B may become equal to the peripheral speed of the outer peripheral surface of the rotary support 14. Additionally, each time the rotary support 14 is rotated 180 degrees, the controller 18 moves the rotary support 14 in the rotation shaft direction X to mold the rubber member such that a portion of the rubber strip members S1 and S2 on the rotary support 14 is overlapped only with a predetermined distance in the rotation shaft direction X, in other words, with a smaller distance than the width dimension (length dimension along the rotation shaft direction X) of the rubber strip members S1 and S2.

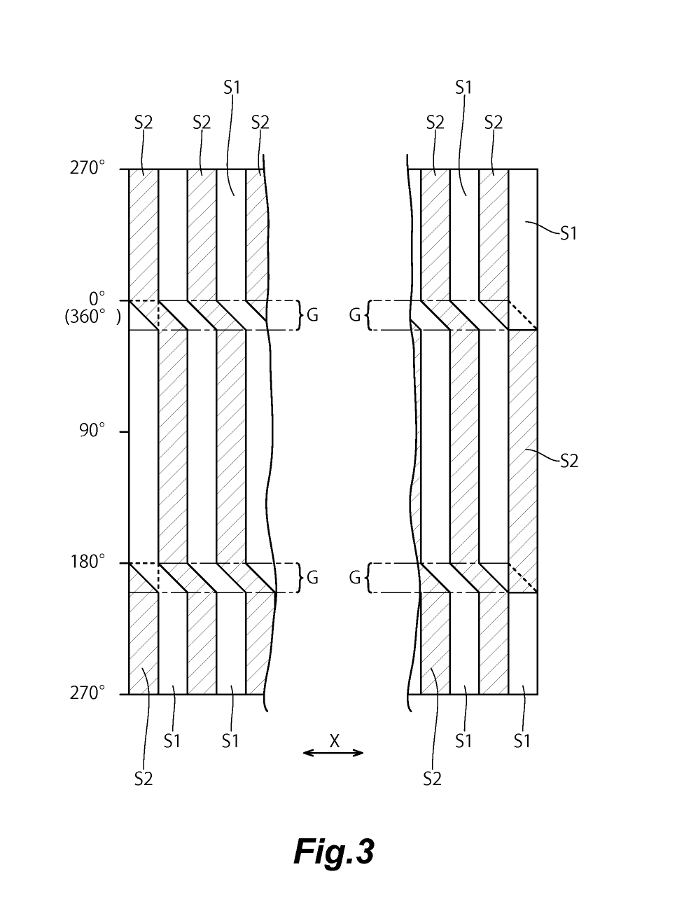

In the manufacturing apparatus 10 of the present embodiment, as described above, the controller 18 controls the two extruders 12A and 12B, and the rotary support 14. Consequently, as illustrated in FIG. 3, the rubber member on which the rubber strip member S1 extruded from one extruder 12A and the rubber strip member S2 extruded from the other extruder 12B are alternatively arranged in the rotation shaft direction X is molded on the outer peripheral surface of the rotary support 14.

As is obvious in FIG. 3, in the present embodiment, the two extruders 12A and 12B which supply the rubber strip members S1 and S2 onto the rotary support 14 are located at the positions which are shifted by 180 degrees around the rotation shaft L of the rotary support 14, and are arranged at the same position in the rotation shaft direction X of the rotary support 14. Therefore, if the rotary support 14 is rotated 180 degrees, it is possible to wind the rubber strip members S1 and S2 around the entire circumference of the rotary support 14. Thus, it is possible to mold the rubber member within a shorter time compared to a case where the rubber strip member is wound by one extruder.

In addition, if the rotary support 14 is moved in the rotation shaft direction X such that while the rotary support 14 being rotated, a portion of the rubber strip members S1 and S2 on the rotary support 14 is overlapped only with a predetermined distance in the rotation shaft direction X, there is formed a region (inclined region) G where the rubber strip members S1 and S2 are wound by being inclined with respect to the circumferential direction of the rotary support 14. In the inclined region G, the movement speed of the rotary support 14 becomes fast according to the movement in the rotation shaft direction X. Therefore, the rubber decrease in quantity compared to a region where the rubber strip members S1 and S2 are wound in parallel to the circumferential direction. In the embodiment, the rotary support 14 moves in the rotation shaft direction X each time the rotary support 14 is rotated 180 degrees. As a result, the inclined region G is arranged at a position which is shifted by 180 degrees in the circumferential direction on the same circle of the rotary support 14, and is arranged at a position which is symmetrical in the circumferential direction. Therefore, the weight balance scarcely worsens in the circumferential direction of the pneumatic tire using the molded rubber member.

In addition, in the embodiment, the rubber strip members S1 and S2 extruded from the two extruders 12A and 12B are wound in parallel to the circumferential direction of the rotary support 14. Accordingly, a protruding surplus rubber portion does not occur at both ends of the molded rubber member, and thus it is unnecessary to cut off the surplus rubber portion after the winding is completed.

In addition, in the embodiment, the rotary support 14 is moved in the rotation shaft direction X with respect to the two extruders 12A and 12B. Therefore, there may be provided one mechanism for moving the rotary support 14 in the rotation shaft direction X and thereby it is possible to miniaturize the manufacturing apparatus 10.

Furthermore, in the above description, a case has been described where the rubber member configuring a portion of the pneumatic tire is molded by directly winding the rubber strip members S1 and S2 on the rotary support 14. However, a separate configuring member may be provided in advance on the rotary support 14, and then the rubber strip members S1 and S2 extruded from the two extruders 12A and 12B may be wound on the configuring member.

What is claimed is:

1. A manufacturing method of a pneumatic tire,
wherein while unvulcanized rubber strip members extruded from two extruders are supplied onto a rotary support, the rotary support is rotated, and at least a portion of the pneumatic tire is molded by winding the rubber strip members onto the rotary support,
wherein the two extruders are located at positions which are mutually shifted by 180 degrees around a rotation shaft of the rotary support, and are arranged at the same position in the rotation shaft direction of the rotary support, and
wherein each time the rotary support is rotated 180 degrees, the two extruders and the rotary support are relatively moved in the rotation shaft direction of the rotary support.

2. The manufacturing method of a pneumatic tire according to claim 1,
wherein the rotary support is moved with respect to the two extruders.

3. A manufacturing apparatus of a pneumatic tire, comprising:
two extruders that extrude unvulcanized rubber strip members;
a rotary support; and
a controller that controls the two extruders and the rotary support,
wherein the two extruders are located at positions which are mutually shifted by 180 degrees around a rotation shaft of the rotary support, and are arranged at the same position in the rotation shaft direction of the rotary support, and
wherein the controller rotates the rotary support while the rubber strip members extruded from the two extruders are supplied onto the rotary support,
wherein each time the rotary support is rotated 180 degrees, the two extruders and the rotary support are relatively moved in the rotation shaft direction of the rotary support, and
wherein at least a portion of the pneumatic tire is molded by winding the rubber strip members onto the rotary support.

4. The manufacturing apparatus of a pneumatic tire according to claim 3,
wherein the controller moves the rotary support with respect to the two extruders.
